(19) United States
(12) Patent Application Publication
(10) Pub. No.: US 2014/0047114 A1
(43) Pub. Date: Feb. 13, 2014

(54) VIRTUAL DESKTOP POLICY CONTROL

(71) Applicants: Jayesh A. Chokshi, Cupertino, CA (US); Natraj Iyer, Milpitas, CA (US); Huseni Hakim Saboowala, Fremont, CA (US); Chandrodaya Prasad, Santa Clara, CA (US)

(72) Inventors: Jayesh A. Chokshi, Cupertino, CA (US); Natraj Iyer, Milpitas, CA (US); Huseni Hakim Saboowala, Fremont, CA (US); Chandrodaya Prasad, Santa Clara, CA (US)

(73) Assignee: Cisco Technology, Inc., San Jose, CA (US)

(21) Appl. No.: 13/584,664

(22) Filed: Aug. 13, 2012

(51) Int. Cl. G06F 15/16

(52) U.S. Cl. 709/225

(57) ABSTRACT

In one implementation, a network device provides virtual desktop policy control. The network device detects a number of sessions hosted by a virtual desktop interface (VDI) server, and performs a comparison of the number of sessions to a predetermined threshold capacity of the network device. When a request for a new session to be hosted by the VDI server is received at the network device, the new session request is forwarded according to the comparison of the number of sessions to the predetermined threshold capacity. In one example, the new request is forwarded to establish a new VDI session with the VDI server but with limited capabilities. For example, the client device of the new VDI session may have access to a generic desktop set of necessary applications but not all applications otherwise available to the client device.

### FIELD

The present disclosures relate to policy control for virtual desktop infrastructure or virtual desktop interfaces (VDI) sessions.

### BACKGROUND

VDI or desktop virtualization provides information services to remote users through a wide area network (WAN). The operating systems and hardware architectures for the remote users are independent from the systems providing the information services. Desktop virtualization is a shared resource model that can be advantageous over the traditional model of personal computers in which each personal computer operates with its own operating system and set of applications. Installation, administration and configuration of the applications are more efficient. Further, because resources are provided as needed, the total cost of the system may be reduced.

However, VDI sessions may require high bandwidth, placing a heavy burden on the WAN. In some situations, the addition of one more VDI session can severely deteriorate the session for all of the remote users. The addition of one additional VDI session may disproportionately detriment previously established VDI sessions.

### BRIEF DESCRIPTION OF THE DRAWINGS

FIG. 1 illustrates an embodiment of a communication system for virtual desktop policy control.

FIG. 2 illustrates an example network device of the embodiment of FIG. 1.

FIG. 3 illustrates another embodiment of a communication system for virtual desktop policy control.

FIG. 4 illustrates an example flow chart for virtual desktop policy control.

### DETAILED DESCRIPTION

### Overview

In one aspect, a system performs a method that comprises detecting, via a processor, a number of sessions hosted by a virtual desktop interface (VDI) server that are being managed by a branch router. The method also includes performing, via the processor, a comparison of the number of sessions to a predetermined threshold capacity of the branch router. In addition, the method includes receiving at the branch router a request for a new session to be hosted by the VDI server, and forwarding the request for the new session according to the comparison of the number of sessions to the predetermined threshold capacity.

In a second aspect, a network device comprises a communication interface configured to receive a request for a virtual desktop interface (VDI) session with a VDI server. The network device also comprises a memory configured to store data indicative of a number of current VDI sessions being managed by the network device that are being hosted by the VDI server and a predetermined threshold capacity for the network device. The network device further comprises a processor configured to compare the number of current VDI sessions to the predetermined threshold capacity for the network device, and forward the request if the number of current VDI sessions is less than the predetermined threshold capacity for the network device.

In a third aspect, a computer readable storage medium stores instructions that are executable by a processor to receive, at a network device, a request for a new session to be hosted by a virtual desktop interface (VDI) server. The instructions executable by the processor also executable to compare a number of sessions currently hosted by the virtual desktop interface (VDI) server via the network device to a predetermined threshold capacity of the network device. The instructions executable by the processor further executable to forward the request for the new session to the VDI server when the number of sessions is less than the predetermined threshold capacity, and execute at least one application at the network device in response to the number of sessions being greater than the predetermined threshold capacity.

### Example Embodiments

Many enterprises employ virtual desktop infrastructure or virtual desktop interface (VDI) systems to save capital expenses and/or operating expenses. However, most enterprises using VDI deployments do not have unlimited or otherwise expansive bandwidth. For example, many VDI employments rely on connections equal or less than 1.5 Mbps (e.g., T1 line). For example, branch offices or locations on a wide area network (WAN) may have bandwidth constraints. The following embodiments effectively expand the bandwidth constraints to increase the number of sessions supported by VDI systems by limiting the bandwidth of certain VDI sessions, or selectively permitting only prioritized VDI sessions to be established, or both.

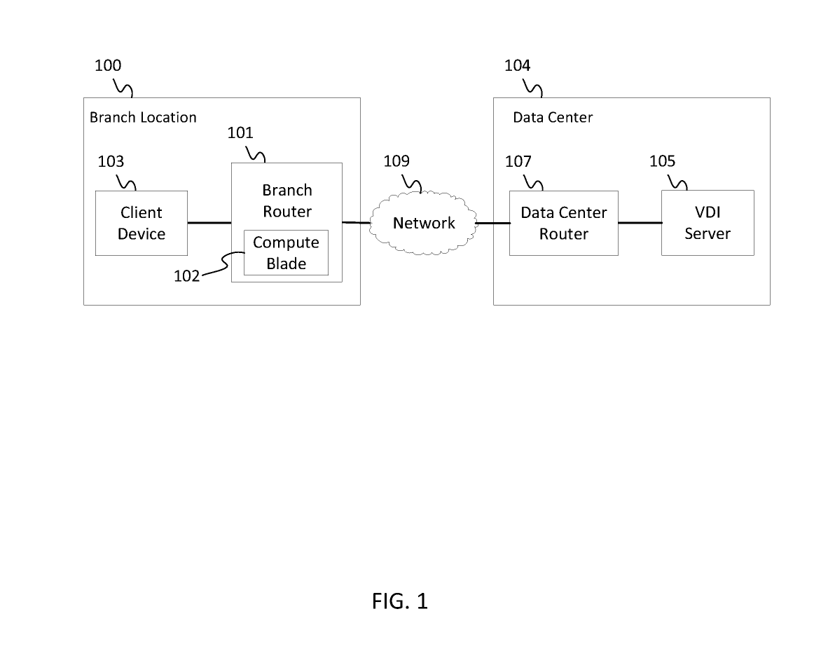

FIG. 1 illustrates an embodiment of a communication system for virtual desktop policy control. The communication system includes a branch location 100 and a data center 104. The branch location 100 and the data center 104 are configured to communicate with one another via a network 109. The network 109 may be a WAN. The communication system may include multiple branch locations 100 that each include one or more client devices 103 and one or more network devices, such as a branch router 101.

The client devices 103 include at least one of a work station, a personal computer, a laptop, a personal digital assistant, a smartphone, or any communication enabled computing device. The client devices 103 may include one or more thin-client hardware devices. Thin-client hardware devices, or slim devices, provide some computing services via a user interfaces but communicate with a server (e.g., VDI server 105) for a majority of computing processes accessed by users. In one example, the thin-client hardware device includes a graphical display, a user interface, and the processing capabilities necessary to communicate with the VDI server 105.

The client devices 103 are configured to communicate with the branch router 101 through any type of connection including but not limited to one or more of an Ethernet connection, a telephone connection, a cellular connection, or another type of wireless connection defined by 802.11 or Bluetooth protocols.

The branch location 100 includes at least the client device 103 and the branch router 101. The data center 104 includes at least the VDI server 105 and the data center router 107. The branch router 101, alone or in combination with branch routers in other branch locations, initiate sessions, such as a VDI session, with the data center 104 that are hosted by the VDI server 105.

A VDI session can be established between a piece of software on the client device 103 and the VDI server 105. Typically, establishing this session involves the user invoking software on the client device 103, followed by an authenticated login procedure. Once the VDI session is established, two-way exchange of information between the client device 103 and the VDI server 105 can commence via the branch router 101. Input information from a user interface, such as a mouse, keyboard and/or other peripherals on the client device 103 can be sent via the branch router 101 to the VDI server 105 in one direction. On the other hand, graphical information, such as screen bitmap information, can be sent from the VDI server 105 via the branch router 101 to the graphical display on the client device 103. In one example, the graphical information can be sent using a display protocol. The display protocol, for example, may help to optimize the sending of graphic changes, such as bitmap changes, over the network.

The branch router 101 detects and counts the total number of current VDI sessions managed by the branch router 101. The branch router 101 may receive data from the VDI server 105 indicative of the total number of current VDI sessions, or the branch router 101 may count the number of sessions originating with the branch location 100. The branch router 101 compares a current count of the number of VDI sessions to a predetermined threshold capacity of VDI sessions managed by the branch router 101. The predetermined threshold capacity may be set by a VDI administrator. The predetermined threshold capacity of the branch router 101 may be determined by the VDI administrator depending on system parameters, such as the WAN bandwidth available at the branch router 101 for VDI traffic. The predetermined threshold capacity of the number of sessions may also be influenced by an estimate of bandwidth needed by each VDI session being managed by the branch router 101. Thus, in one example, the predetermined threshold capacity of the number of sessions of the branch router 101 may be determined by:

Threshold Capacity=WAN bandwidth available for VDI/Estimated bandwidth per VDI session.

The predetermined threshold capacity of the branch router 101 may be entered directly to an interface connected to the VDI server 105 or the branch router 101 or remotely through the network 109.

When the branch router 101 receives a request for a new session, the branch router 101 forwards the request for the new session. In one example, the request may be forwarded according to the comparison of the number of currently managed VDI sessions to the predetermined threshold capacity of the branch router 101. The branch router 101 may forward the request by writing a policy field to the request. For example, if the current number of VDI sessions at the branch router 101 is less than the predetermined threshold capacity of the branch router 101, the branch router 101 may indicate this information in the policy field, and the new session may be established with the VDI server 105 according full access. If, on the other hand, the current number of VDI sessions of the branch router 101 is greater than the predetermined threshold capacity of the branch router 101, the branch router 101 may indicate this information in the policy field, and the new session may be established with the VDI server 105 according to partial access or no access.

Partial access may be defined as less than a complete virtual desktop (e.g., a partial virtual desktop). The partial virtual desktop may include, for example, only mission critical applications. The mission critical applications may be defined by one or more of a criticality value or a bandwidth requirement value. Further, if the current number of sessions is greater than the predetermined threshold capacity of the branch router 101, the new session may also include the partial desktop of applications. The partial desktop of applications may be executed by a compute blade 102 included in the branch router 101 that accesses limited data (e.g., less than optimal data or periodic data) from the VDI server 105.

A chassis of the branch router 101 may be populated with one or more compute blades 102. The compute blade 102 may include a processor that is separate from the processor used for the branch router's control/data/management plane functions. In addition, the compute blade 102 may be used to host applications and services, such as VDI services. Thus, the compute blade 102 may allow management of partial desktop applications by the branch router 101 without significantly increasing the processing burden on the processor used for the branch router's control/data/management plane functions. Alternatively, or in addition, the partial desktop applications may be executed by the processor of the branch router 101, or any other device in communication with the branch router 101.

The criticality value of a plurality of application may be configured by the administrator of the branch location 100. The criticality value may have at least two possible values (e.g., critical and non-critical) or the criticality value may be a rating on a scale (e.g., a scale from one to ten). The bandwidth requirement value of a plurality of applications may be configured by the administrator of the branch location 100. The bandwidth requirement value may have at least two possible values (e.g., high bandwidth and low bandwidth), the bandwidth requirement value may be a rating on a scale, or the bandwidth requirement value may be proportional to the actual bandwidth requirement measured in bitrate (e.g., kilobytes/second, megabytes/second).

When the number of sessions exceeds or equals the maximum threshold of the branch router 101, the new session may be denied or delayed by the branch router 101. Alternatively, the branch router 101 may host the partial virtual desktop with no communication to the VDI server 105. The branch router 101 may rely on cached data or estimated data rather than communication with the data center 104.

In addition or in the alternative, the branch router 101 may be configured to receive a policy value for the user that requested the VDI session. When the branch router 101 receives a request for a new session from the user, the branch router 101 forwards the request for the new session according to a comparison of the policy value to a threshold policy value.

The network 109 facilitates data communication between the data center 104 and the branch offices 100 through a variety of protocols in lower three layers of the OSI reference model: the physical layer, the data link layer, and the network layer. The network 109 may communicate over or in cooperation with the Internet. The client device 103 and the branch location 100 that requests data from the VDI server 105 may be at one geographic location, and the data center 104 and the VDI server 105 may be at another geographic location.

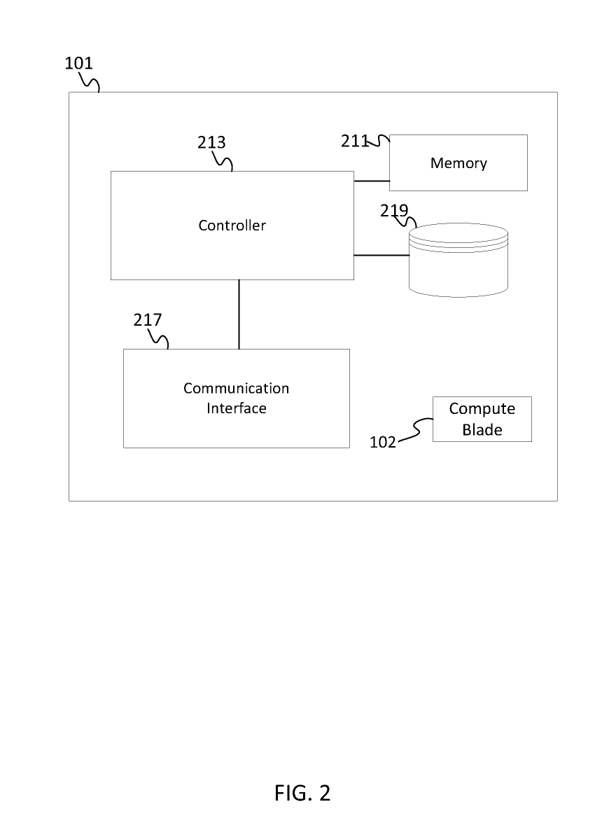

FIG. 2 illustrates an example network device of the embodiment of FIG. 1. The network device may be the branch router 101. The chassis of the branch router 101 may be populated with at least one compute blade 102 to run applications and/or services. In addition, the branch router 101 may include a memory 211, a controller or processor 213, a communication interface 217, and a database 219. Alternatively, the embodiments described below may be incorporated into any of a variety of network devices includes servers, switches, or gateways.

The memory 211 stores at least one of a predetermined threshold capacity of VDI sessions for the branch router 101 or a predetermined threshold priority value of a user to establish a session with the VDI server 105. One or both of the predetermined threshold capacity for the branch router 101, and the predetermined threshold priority value may be set, configured, or adjusted by an administrator device. The administrator device may be accessed by an administrator of the communication system through communication with the branch router 101 or the VDI server 105.

The plurality of branch locations 100 may have independently set and configurable predetermined threshold capacity values and predetermined threshold priority values. Examples for the predetermined threshold capacity values for the number of VDI sessions include 5, 10, 100 or any integer value. Examples for the predetermined threshold prior values may be on a scale (e.g., a scale from 1 to 5 where 5 is the highest priority). The controller 213 is configured to receive one or more of the predetermined threshold capacity for the branch location 100 and the predetermined threshold priority value from the administrator or an input device and write either or both values to memory 211. The controller 213 may be configured to establish a new session when the priority is a high priority and deny a new session when the priority is a low priority. Whether the priority is high or low may be defined based on the comparison with the predetermined threshold priority value. The controller 213 may be configured to generate a denial message that indicates that the new session has been denied when the number of sessions for the branch router 101 is greater than the predetermined threshold capacity and the priority is less than the predetermined priority threshold.

The communication interface 217 may be configured to receive a request for a VDI session through communication with network 109 from a client device 103. The request for the VDI session can include a network address of a server, such as the address of a VDI broker/server and authentication information. The VDI session request can be vendor dependent, such as a VMware™ view or a Citrix Xendesktop™

The controller or processor 213 is configured to receive the request for the VDI session and increment the number of current VDI sessions stored in the memory 211. The processor 213 compares the number of current VDI sessions managed by the branch router 101 to the predetermined threshold capacity value stored in the memory 211. The processor 213 is configured to forward the request for the VDI session according to the comparison.

In one embodiment, the processor 213 is configured to monitor the number of sessions with respect to the predetermined threshold capacity and connect the client device 103 to the data center 104 when the number of sessions is below the predetermined threshold capacity.

In one embodiment, when the current number of VDI sessions managed by the branch router 101 exceeds the predetermined threshold capacity, the new request for a VDI session is denied. When the current number of VDI sessions does not exceed the predetermined threshold capacity, the request for the VDI session is forwarded to the data center 104 and/or the VDI server 105.

In another embodiment, when the user's priority exceeds the priority threshold, and the current number of VDI sessions exceeds the predetermined threshold capacity, the new request is handled by the branch router 101. For example, the branch router 101 may execute a partial virtual desktop, which is discussed in more detail below. When the current number of VDI sessions does not exceed the predetermined threshold capacity of the branch router 101, the request for the VDI session is forwarded to the data center 104 and/or the VDI server 105.

The partial virtual desktop may be defined on a branch level or on a user level. The partial virtual desktop includes less than all of the applications normally available at the branch or to the user. All of the applications normally available may be referred to as a complete desktop. The partial virtual desktop may include only mission critical applications. Mission critical applications are software applications that are necessary to accomplish a primary function of the user, of the branch location 100, or of the enterprise. Mission critical applications may be listed by a data file or a user specific profile stored in the memory 211 and configurable by the administrator.

To the extent that the desktop is generic to one or more users of a job function or a branch location 100, the partial virtual desktop may be referred to as a generic desktop. Even though the generic desktop is less than a complete desktop, the generic desktop may include user selectable features that present a normal appearance or feel to the user. Such user selectable features may include, wallpaper, icons, menu settings, color settings, registry settings, and other features. The user selectable features and settings may be stored in a user desktop configuration file in the memory 211.

The partial virtual desktop may be provided independently by the branch router 101 alone. Alternatively, or in addition, the partial virtual desktop may be provided by the branch router 101 with supplemental data from the data center 104 or the VDI server 105. That is, in some scenarios, all of the data necessary to support at least one mission critical application running on the branch router 101 is stored in memory 211 or otherwise available to the branch router 101 without receiving data from the network 109. The WAN may be inoperable but services are still provided to the client device 103. In other scenarios, at least one mission critical application running on the branch router 101 communicates through the network 109 to receive data to run the mission critical applications. Examples include a bank teller application that receives account information and balances from the data center 104 but can be executed at the branch location 100, or a point of sale application that receives credit card authorization or inventory information from the data center 104 but can be executed at the branch location 100.

In an example embodiment, in scenarios in which at least one mission critical application is running on the branch router 101 but accessing data from the data center 104, the request for a VDI session may be modified before sending the request to the VDI server 105. The modification may flag the request to indicate that the bandwidth to the branch location 100 is nearing capacity or that the request should be allocated only limited data or a limited VDI session. The processor 213 may be configured to make such a modification to a limited VDI session if the number of current VDI sessions is greater than the predetermined threshold capacity for the branch router 101.

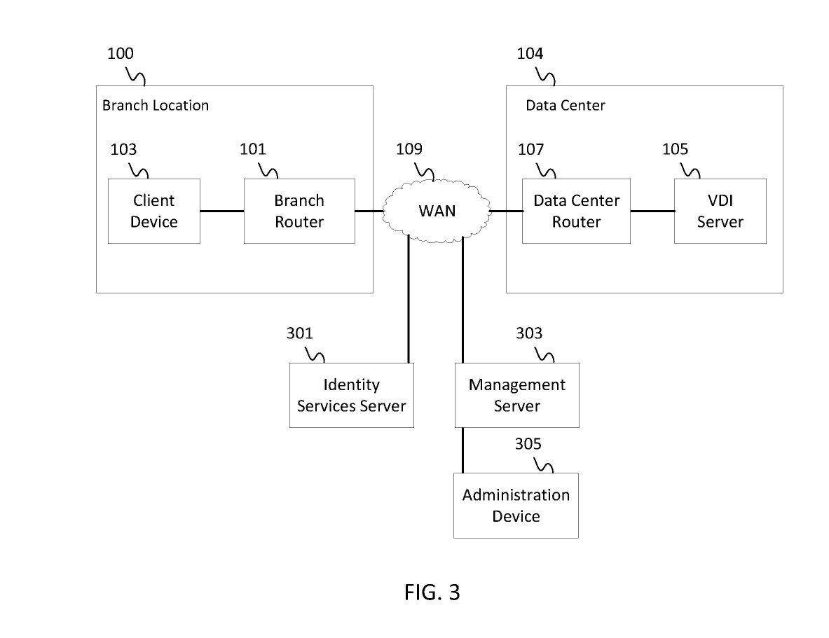

FIG. 3 illustrates another embodiment of a communication system for virtual desktop policy control. The communication system includes a branch location 100 and a data center 104, as discussed above. The communication system also includes an identity services server 301, a management server 303, and an administration device 305. The identity services server 301 may include an identity service engine (ISE) for policy definitions. The ISE policy definitions apply a priority value to users, devices, or locations.

For example, the ISE may include a database or a lookup table that assigns priority values according to user roles, job functions, or classifications in the branch location 100. Examples may include engineer, accountant, programmer, human resources associate, or information technology specialist. The ISE may associate each role to a generic desktop and/or a subset of available applications. For example, a programmer may be associated with developer software and a human resources associate may be associated with payroll software. The branch router 101 may be configured to access the policy or priority value of the user of the client device 103 from the ISE database and define the generic desktop and/or subset of available applications according to the job function or classification of the user.

In another example, the ISE database or lookup table may associate priority values according to specific devices, types of devices, or connection types. Wired devices directly connected to the network of the branch location 100 may have a higher priority than wireless devices using Wi-Fi or Bluetooth. Authenticated devices may have a higher priority than guest devices. Personal computers may have a higher priority than smartphones and/or tablets.

In another example, the ISE database or lookup table may additionally or alternatively associate priority values according to time and location. Devices (e.g., guest devices or unauthenticated devices) may be associated with a higher priority during off-peak hours (e.g., after 5 P.M.) than during peak hours. Devices located in secured areas may be associated with a higher priority than devices located in public areas.

In any of the above examples, the processor 213 queries the lookup table or database 219 by way of the identity services server 301 for the priority values associated with each client device 103, such as when the client device requests a VDI session. The communication interface 217 receives the priority value associated with the request for the VDI session from the ISE of the identity services server 301. Alternatively, the ISE may be included in the branch router 101 in database 219.

The processor 213 determines whether or not to allow the VDI session or whether or not to allow only limited access to the VDI session depending on the number of current VDI session managed by the branch router 101, and the priority value associated with the VDI session. For example, the processor 213 is configured to forward the request for the VDI session if the priority value is greater than a predetermined threshold priority value. The processor 213 may be configured to modify the request for the VDI session to a request for a limited VDI session if the priority value is less than the predetermined threshold priority value. The VDI server 105 interprets the request for the limited VDI session to provide limited information to the VDI session. Limited information may include only mission critical data.

Alternatively, one or both of the predetermined threshold capacity for the branch router 101, and the predetermined threshold priority value may be dynamically adjusted according to a network performance parameter. The network performance parameter may include speed, throughput, latency, packet loss, quality of service (QoS) or another parameter. For example, branch router 101 may be configured to detect a speed of one or more existing VDI sessions. In addition, the branch router 101 may increase the predetermined threshold capacity as the speed increases, and decrease the predetermined threshold capacity as the speed decreases. Alternatively, or in addition, the branch router 101 may be configured to increase the predetermined threshold priority value as the speed increases and to decrease the predetermined threshold priority value as the speed decrease. Any of the network performance parameters may be detected to adjust one or both of the predetermined threshold capacity for the branch router 101 and the predetermined threshold priority value.

The management server 303 provides remote access, configuration, and administration for the branch router 101 and the VDI server 105. The management server 303 may perform the comparison of the number of sessions currently hosted by the VDI server 105 to the predetermined threshold capacity. The branch router 101 may report the count of the number of sessions managed by the branch router 101 to the management server 303. Alternatively, the branch router 101 may generate a message including data indicative of the comparison of the number of sessions to the threshold capacity and send the message to the management server 303.

The administration device 305 is configured to receive commands from an administrator regarding the configuration of the branch router 101 or the VDI server 105. One or both of the predetermined threshold capacity for the branch router 101 and the predetermined threshold priority value may be set, configured, or adjusted by an administrator device 305. The administrator device 305 may be accessed by an administrator of the communication system through communication with the branch router 101, the VDI server 105, or the management server 303, as shown by FIG. 3.

The memory 211 may be any known type of volatile memory or a non-volatile memory. The memory 211 may include one or more of a read only memory (ROM), dynamic random access memory (DRAM), a static random access memory (SRAM), a programmable random access memory (PROM), a flash memory, an electronic erasable program read only memory (EEPROM), static random access memory (RAM), or other type of memory. The memory 211 may include an optical, magnetic (hard drive) or any other form of data storage device. The memory 211 may be located in a remote device or removable, such as a secure digital (SD) memory card.

The memory 211 may store computer executable instructions for filtering and routing communication session requests. The controller 213 may execute computer executable instructions. The computer executable instructions may be included in computer code. The computer code may be written in any computer language, such as C, C++, C#, Java, Pascal, Visual Basic, Perl, HyperText Markup Language (HTML), JavaScript, assembly language, extensible markup language (XML) and any combination thereof.

The computer code may be stored in one or more tangible media or one or more non-transitory computer readable storage media for execution by the controller 213. A computer readable storage medium may include, but is not limited to, a floppy disk, a hard disk, an application specific integrated circuit (ASIC), a compact disk CD, other optical medium, a random access memory (RAM), a read only memory (ROM), a memory chip or card, a memory stick, and other media from which a computer, a processor or other electronic device can read.

The controller or processor 213 may include a general processor, digital signal processor, application specific integrated circuit, field programmable gate array, analog circuit, digital circuit, server processor, combinations thereof, or other now known or later developed processor. The controller or processor 213 may be a single device or combinations of devices, such as associated with a network or distributed processing. Any of various processing strategies may be used, such as multi-processing, multi-tasking, parallel processing, remote processing, centralized processing or the like. The controller or processor 213 may be responsive to or operable to execute instructions stored as part of software, hardware, integrated circuits, firmware, micro-code or the like.

The communication interface 217 may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other or through one or more intermediate entities (e.g., processor, operating system, logic, software). Logical and/or physical communication channels may be used to create an operable connection. As used herein, the phrases “in communication” and “coupled” are defined to mean directly connected to or indirectly connected through one or more intermediate components. Such intermediate components may include both hardware and software based components.

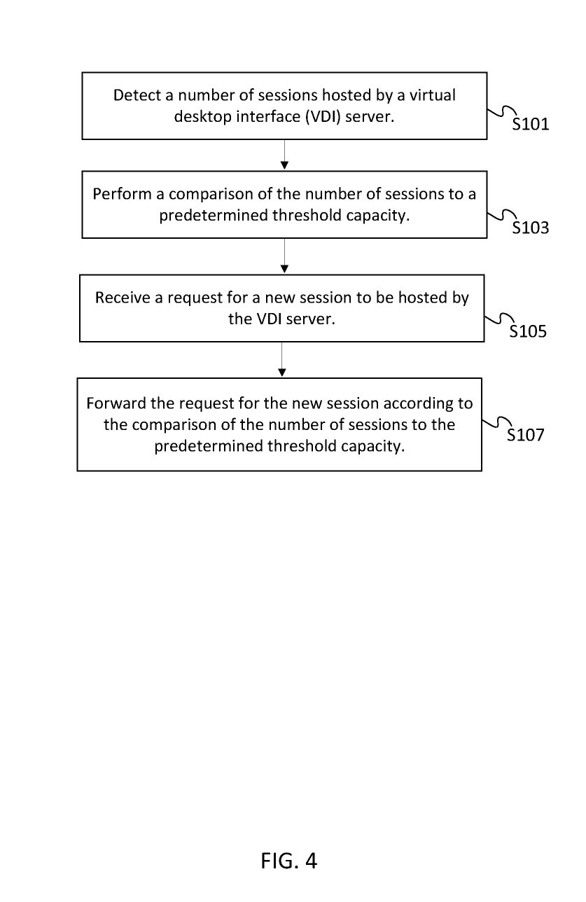

FIG. 4 illustrates an example flow chart for virtual desktop policy control. The algorithm in the example flow chart may be performed by a network device, such as controller 213 of the branch router 101. Alternatively, the algorithm of the example flow chart may be performed by a comparable controller or processor in the VDI server 105, the management server 303, or another network device.

At act S101, the controller detects a number of sessions hosted by the VDI server 105 that are being managed by the branch router 101. The sessions originate with client devices 103. The client devices 103 may be located in the branch location 100 or spread across more than one branch location 100. The sessions from each branch location or group of branch locations share a limited amount of bandwidth for communication with the data center 104 via the branch router 101.

At act S103, the controller performs a comparison of the number of sessions to a predetermined threshold capacity of the branch router 101. The predetermined threshold capacity may be stored locally in memory. The predetermined threshold capacity may be assigned to the branch location 100 by an administrator or the predetermined threshold capacity may be dynamically determined by the controller according to diagnostics of the network 109 or a particular data flow for an existing. VDI session.

Optionally or in addition, the controller may perform a comparison of a priority associated with the new session from an identity services engine (ISE). The network device is configured to execute software applications when the number of sessions is less than the predetermined threshold capacity and when the number of sessions is greater than the predetermined threshold capacity and the priority is greater than a predetermined priority threshold. The priority may indicate the type of device (e.g., mobile devices versus permanent devices), the location of the device (secured location versus public location), the connection type of the device (secured connection versus public connection), or the credentials of the user. The credentials of the user may relate to access rights or the classification of the user. The classification may define the type of work, and accordingly, software applications that the user requires.

At act S105, the controller receives a request for a new session to be hosted by the VDI server 105. The request for the new session may identify the priority of the client device 103 or user that initiated the request. The request for the new session may include a source address of the client device 103.

At act S107, the controller forwards the request for the new session according to the comparison of the number of sessions to the predetermined threshold capacity of the branch router 101 and/or the comparison of the priority from the ISE to the priority threshold. In one example, the controller is configured to identify three possibilities for forwarding the request.

In a first possibility, when the number the number of sessions is more than a maximum threshold capacity for the branch router 101, no new sessions can be established. The controller is configured to generate a denial message indicating that the new session has been denied and transmit the denial message to the client device 130 that requested the new session.

In a second possibility, when the number of sessions is more than the predetermined threshold capacity and less than maximum threshold capacity for the branch router 101, the controller may forward the request to the VDI server 105 with partial access. Alternatively, the control may perform additional analysis. For example, the additional analysis may involve the policy of the user of the client device 130. When the policy is rated higher than the predetermined priority, the controller forwards the request to the VDI server 105 with partial access, but when the policy is rater lower than the predetermined priority, the controller denies or delays the request for the new VDI session.

Partial access may include less than all application normally available to the client device 130 from the VDI server 105 in a VDI session. Partial access may include provision by the branch router 101 of a generic desktop to the client device 130 that requested the new session. The generic desktop may configured by the administrator or defined according to the job description of the user.

Various embodiments described herein can be used alone or in combination with one another. The foregoing detailed description has described only a few of the many possible implementations of the present embodiments. For this reason, this detailed description is intended by way of illustration, and not by way of limitation.

We claim:

1. A method comprising:
detecting, via a processor, a number of sessions hosted by a virtual desktop interface (VDI) server that are being managed by a branch router;
performing, via the processor, a comparison of the number of sessions to a predetermined threshold capacity of the branch router;
receiving at the branch router a request for a new session to be hosted by the VDI server; and
forwarding the request for the new session according to the comparison of the number of sessions to the predetermined threshold capacity.

2. The method of claim 1, wherein the number of sessions is more than the predetermined threshold capacity and less than a maximum threshold capacity for the branch router.

3. The method of claim 2, further comprising:
receiving a priority associated with the new session from an identity services engine.

4. The method of claim 3, furthering comprising:
establishing the new session when the priority is a high priority; and
denying the new session when the priority is a low priority.

5. The method of claim 1, further comprising:
establishing the new session with a generic desktop including one or more applications configured to be executed by the VDI server.

6. The method of claim 5, wherein the generic desktop includes at least one application defined according to a policy of a user that initiated the request for the new session.

7. The method of claim 1, further comprising:
monitoring the number of sessions with respect to the predetermined threshold capacity; and
connecting the new session to a data center when the number of sessions is below the predetermined threshold capacity.

8. The method of claim 1, further comprising:
generating a message including data indicative of the comparison of the number of sessions to the predetermined threshold capacity; and
sending the message to a management server.

9. A network device comprising:
a communication interface configured to receive a request for a virtual desktop interface (VDI) session with a VDI server;
a memory configured to store data indicative of a number of current VDI sessions being managed by the network device that are being hosted by the VDI server and a predetermined threshold capacity for the network device; and
a processor configured to compare the number of current VDI sessions to the predetermined threshold capacity for the network device, and forward the request if the number of current VDI sessions is less than the predetermined threshold capacity for the network device.

10. The network device of claim 9, wherein the processor is configured to modify the request for the VDI session to a request for a limited VDI session if the number of current VDI sessions is greater than the predetermined threshold capacity for the network device.

11. The network device of claim 10, wherein the processor is configured to deny the request for the VDI session if the number of current VDI sessions is equal to a maximum threshold capacity for the network device.

12. The network device of claim 9, wherein the communication interface is configured to receive a priority value associated with the request for the VDI session from an identity services engine.

13. The network device of claim 12, wherein the processor is configured to forward the request for the VDI session if the priority value is greater than a predetermined threshold priority value.

14. The network device of claim 13, wherein the processor is configured to modify the request for the VDI session to a request for a limited VDI session if the priority value is less than the predetermined threshold priority value.

15. The network device of claim 14, wherein the processor is configured to host a generic desktop including at least one mission critical application but less than a complete desktop for a user that initiated the request for the VDI session.

16. A computer readable storage medium storing instructions, the stored instructions executable by a processor to:
receive, at a network device, a request for a new session to be hosted by a virtual desktop interface (VDI) server;
compare a number of sessions currently hosted by the virtual desktop interface (VDI) server via the network device to a predetermined threshold capacity of the network device;
forward the request for the new session to the VDI server when the number of sessions is less than the predetermined threshold capacity; and
execute at least one application at the network device in response to the number of sessions being greater than the predetermined threshold capacity.

17. The computer readable storage medium of claim 16, further comprising instructions executable by the processor to:
receive a priority associated with the new session from an identity services engine; and
execute the at least one application at the network device in response to the number of sessions being greater than the predetermined threshold capacity and the priority being greater than a predetermined priority threshold.

18. The computer readable storage medium of claim 17, further comprising instructions executable by the processor to:
generate a denial message indicating that the new session has been denied in response to the number of sessions being greater than the predetermined threshold capacity and the priority being less than the predetermined priority threshold; and
transmit the denial message for receipt by a client device that requested the new session.

19. The computer readable storage medium of claim 16, further comprising instructions executable by the processor to:
provide a generic desktop to a client device in response to the request for the new session, wherein the generic desktop includes the at least one application executed at the network device.

20. The computer readable storage medium of claim 19, further comprising instructions executable by the processor to:
access a policy of a user of the client device from a policy database, wherein the policy database associates the user with the at least one application defined by a job function or classification of the user; and
define the generic desktop according to the job function or classification of the user.
